(19) United States
(12) Patent Application Publication
(10) Pub. No.: US 2025/0344143 A1
(43) Pub. Date: Nov. 6, 2025

(54) METHODS FOR HANDLING PDCP PDU IN SPLIT GNB ARCHITECTURE

(71) Applicant: TELEFONAKTIEBOLAGET LM ERICSSON (PUBL), Stockholm (SE)

(72) Inventors: Du Ho KANG, Sollentuna (SE); Jose Luis PRADAS, Stockholm (SE); Nianshan SHI, Järfälla (SE); Yazid LYAZIDI, HASSELBY (SE)

(21) Appl. No.: 18/855,471

(22) PCT Filed: Apr. 21, 2023
(86) PCT No.: PCT/IB2023/054124

§ 371 Date: Oct. 9, 2024

Related U.S. Application Data
(60) Provisional application No. 63/333,868, filed on Apr. 22, 2022.

(51) Int. Cl. H04W 48/20; H04W 28/02; H04W 28/06; H04W 92/20

(52) U.S. Cl. CPC H04W 48/20; H04W 28/0268; H04W 28/06; H04W 92/20

(57) ABSTRACT

Systems and methods for handling delivery of data units associated with XR application network traffic in a split gNB architecture are provided. A radio access node centralized unit (CU) can select a radio access node distributed unit (DU) for transmitting a PDU Set based on PDU Set assistance information. The CU transmits the PDU Set and its associated PDU Set assistance information to the selected DU. The DU can determine whether the PDU Set will be transmitted or discarded based on the associated PDU Set assistance information.

### CROSS REFERENCE TO RELATED APPLICATIONS

This application claims the benefit of U.S. Provisional Application No. 63/333,868 filed on Apr. 22, 2022, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system NR will support a diverse set of use cases and a diverse set of deployment scenarios. The later includes deployment at both low frequencies (e.g. 100 s of MHz), similar to LTE today, and very high frequencies (e.g. mm waves in the tens of GHz).

5G is the fifth generation of mobile communications, addressing a wide range of use cases from Enhanced Mobile Broadband (eMBB) to Ultra-Reliable Low-Latency Communications (URLLC) to Massive Machine Type Communications (mMTC). 5G includes the New Radio (NR) access stratum interface and the 5G Core Network (5GC). The NR physical and higher layers are reusing parts of the LTE specification, and to that add needed components when motivated by new use cases.

Low-latency high-rate applications such as eXtended Reality (XR) and cloud gaming are important in 5G era. XR may refer to all real-and-virtual combined environments and human-machine interactions generated by computer technology and wearables. It is an umbrella term for different types of realities including Virtual Reality (VR), Augmented Reality (AR), Mixed Reality (MR), and the areas interpolated among them. The levels of virtuality range from partially sensory inputs to fully immersive VR.

5G/NR is designed to support applications demanding high rate and low latency in line with the requirements posed by the support of XR and cloud gaming applications in NR networks. 3GPP Release 17 contains a study item on XR Evaluations for NR. The main objectives are to identify the traffic model for each application of interest, the evaluation methodology and the key performance indicators of interest for relevant deployment scenarios, and to carry out performance evaluations accordingly in order to investigate possible standardization enhancements.

### Low-Latency High-Rate XR Applications

The low-latency applications like XR and cloud gaming require “bounded latency”, not necessarily ultra-low latency. The end-to-end latency budget may be in the range of 20-80 ms which needs to be distributed over several components including application processing latency, transport latency, radio link latency, etc. For these applications, short transmission time intervals (TTIs) or mini-slots targeting ultra-low latency may not be effective.

FIG. 1 illustrates an example of frame latency measured over radio access network (RAN), excluding application and core network latencies. It can be noted that frame latency spikes exist in RAN. The latency spike(s) occur due to instantaneous shortage of radio resources or inefficient radio resource allocation in response to varying frame size. The sources of the latency spikes can include queuing delay, time-varying radio environments, time-varying frame sizes, among others. Tools that can help to remove latency spikes may be beneficial to enable better 5G support for this type of traffic

In addition to bounded latency requirements, the applications like XR and cloud gaming also require high-rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

A large video frame is usually fragmented into smaller IP packets and transmitted as several Transport Blocks (TBs) over several TTIs in RAN. FIG. 2 illustrates an example of the cumulative distribution functions of the number of transport blocks required to deliver a video frame with size ranging from 20 KB to 300 KB. For example, FIG. 2 shows that for delivering the frames with a size of 200 KB each, the median number of needed TBs is 5.

The characteristics of XR traffic arrival are quite distinct from typical web-browsing and VoIP traffic as shown in FIG. 3. It is expected that the arrival time is quasi-periodic and largely predictable as VoIP. However, its data size is order of magnitude larger than VoIP, as discussed above. In addition, similar to web-browsing, the data size is different at every application PDU arrival instance due to the dynamic nature of the contents and human motion.

### SUMMARY

It is an object of the present disclosure to obviate or mitigate at least one disadvantage of the prior art.

There are provided systems and methods for handling delivery of data units associated with XR application network traffic in a split gNB architecture.

In a first aspect there is provided a method performed by a radio access node centralized unit (CU). The CU can comprise a radio interface and processing circuitry and be configured to receive a packet data unit (PDU) Set and associated PDU Set assistance information. The CU selects a radio access node distributed unit (DU) for transmitting the PDU Set based at least in part on the PDU Set assistance information; and transmits the PDU Set and the associated PDU Set assistance information to the selected DU.

In some embodiments, the PDU Set assistance information is received in a GTP-U extension header.

In some embodiments, the PDU Set assistance information includes at least one of: a PDU Set Sequence Number, a PDU Set Size, and a PDU sequence number within the PDU Set.

In some embodiments, the CU receives an importance indication indicating a relative importance of the PDU Set compared to at least one other PDU Set. The importance indication can be included in the received PDU Set assistance information. The selection of the DU can be made in accordance with the importance indication.

In some embodiments, the CU further receives an indication of whether the PDU Set will be transmitted or discarded from the selected DU. In response to receiving the indication, the CU can transmit the PDU Set and the associated PDU Set assistance information to a second DU over F1 signaling.

In some embodiments, the CU can transmit the PDU Set and the associated PDU Set assistance information to a second CU over Xn signaling.

In some embodiments, the PDU Set assistance information is transmitted, to the selected DU, in a GTP-U extension header. In other embodiments, the PDU Set assistance information is transmitted, to the selected DU, in an Assistance Information Data information element.

In some embodiments, the CU transmits, to the selected DU, an importance indication indicating a relative importance of the PDU Set compared to at least one other PDU Set. The importance indication is included in the transmitted PDU Set assistance information.

In another aspect there is provide a method performed by a radio access node distributed unit (DU). The DU can comprise a radio interface and processing circuitry and be configured to receive a packet data unit (PDU) Set and associated PDU Set assistance information from a radio access node centralized unit (CU). The DU determines whether the PDU Set will be transmitted or discarded based at least in part on the PDU Set assistance information; and discards the PDU Set in accordance with the determination.

In some embodiments, the DU transmits the PDU Set in accordance with the determination.

In some embodiments, the DU further transmits, to the CU, an indication of whether the PDU Set will be transmitted or discarded. The indication can include at least one of: a PDU sequence number, a Traffic Flow identifier, and a delivery time for the PDU Set.

In some embodiments, the PDU Set assistance information is received in a GTP-U extension header. In other embodiments, the PDU Set assistance information is received in an Assistance Information Data information element.

In some embodiments, the PDU Set assistance information includes at least one of: a PDU Set Sequence Number, a PDU Set Size, and a PDU sequence number within the PDU Set.

In some embodiments, the DU receives an importance indication indicating a relative importance of the PDU Set compared to other PDU Sets. The importance indication can be included in the received PDU Set assistance information. In some embodiments, the determination of whether the PDU Set will be transmitted or discarded is in accordance with the importance indication.

In some embodiments, the DU further receives delivery requirements associated with the PDU Set including at least one of: a latency requirement, a QoS requirement, and a packet delay budget information. The determination of whether the PDU Set will be transmitted or discarded can be made further in accordance with the delivery requirements.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example of frame latency;

FIG. 2 illustrates an example of transport blocks required to deliver a video frame;

FIG. 3 illustrates an example of XR traffic characteristics;

FIG. 4 is an example communication system;

FIG. 5 illustrates an example of multiple PDCP packet arrivals;

FIG. 6 illustrates an example F1 interface between gNB-CU and gNB-DU;

FIG. 7 is a flow chart illustrating a method performed by a gNB-CU;

FIG. 8 is a flow chart illustrating a method performed by a gNB-DU;

FIG. 9 is a block diagram of an example wireless device;

FIG. 10 is a block diagram of an example network node;

FIG. 11 is a block diagram of an example host;

FIG. 12 is a block diagram illustrating an example virtualization environment; and

FIG. 13 is a communication diagram of a host communicating via a network node with a UE.

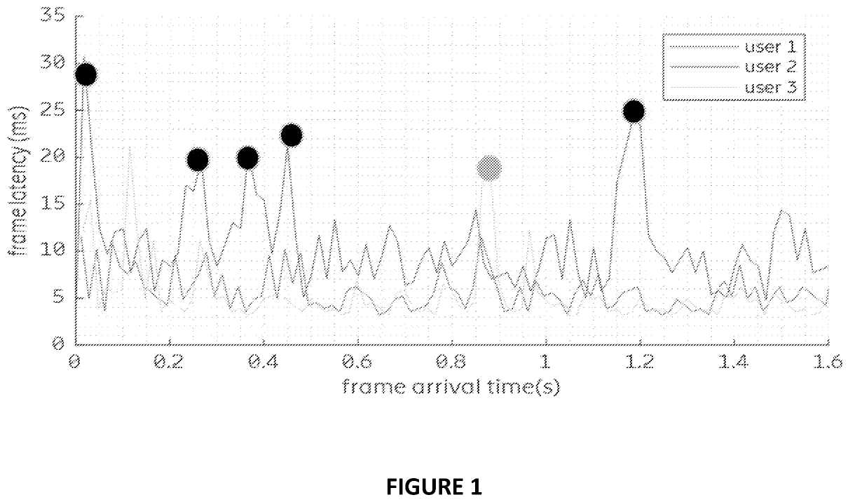

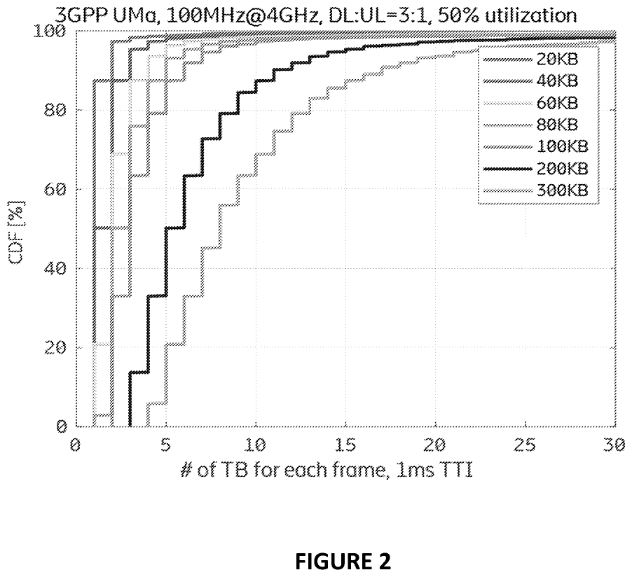

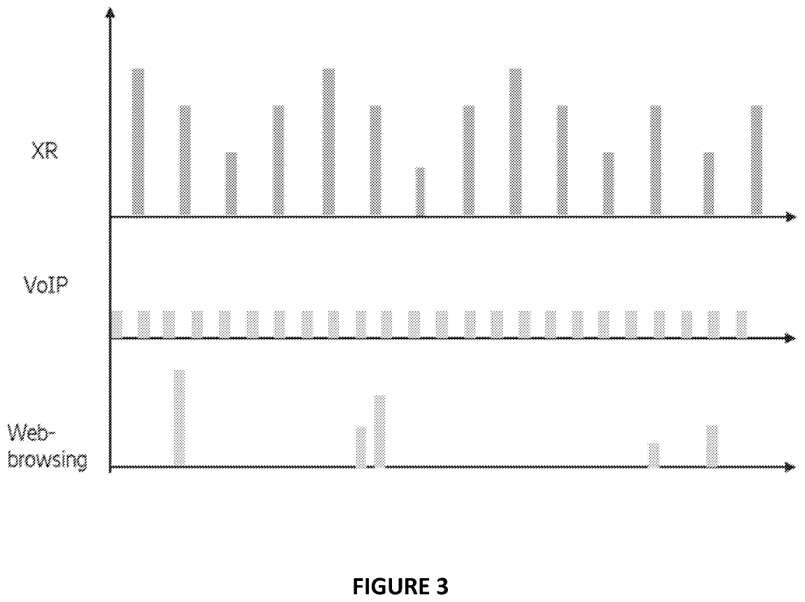

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

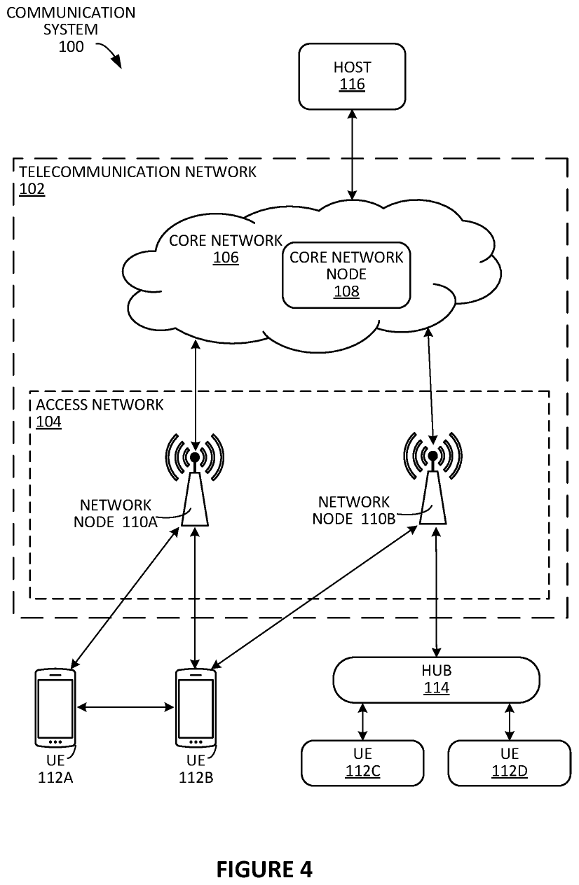

FIG. 4 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110A and 110B (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g. core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Location Management Function (LMF), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 114 communicates with the access network 104 to facilitate indirect communication between one or more UEs (e.g. UE 112C and/or 112D) and network nodes (e.g. network node 110B). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110B. The hub 114 may also allow for a different communication scheme and/or schedule between the hub 114 and UEs (e.g. UE 112C and/or 112D), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110B. In other embodiments, the hub 114 may be a non-dedicated hub—that is, a device which is capable of operating to route communications between the UEs and network node 110B, but which is additionally capable of operating as a communication start and/or end point for certain data channels.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

Returning to the discussion of low-latency applications such as XR, there currently exists certain challenges. XR Application Protocol Data Units (PDUs) (herein, the term Application Data Unit (ADU) will be used interchangeably) may have time constrains. This means that one, or a set, of application PDUs may need to reach the receiver within a certain period of time i.e., with a limited latency. If the application PDU(s) is/are not received by this time, the application PDU(s) is/are not of any use and can be discarded.

As indicated above, the Packet Data Convergence Protocol (PDCP) starts a discard timer each time a PDCP Service Data Unit (SDU) is received by the higher layers. However, the PDCP layer does not have any indication of how many PDCP SDUs correspond to a certain application PDU (or how many IP PDUs correspond to one application PDU). IP packets reach PDCP with certain jitter as they may need to traverse the Internet as well as the 3GPP core network.

For example, one XR application PDU is segmented into five IP packets and each IP packet arrives in sequence, or out of sequence, to the PDCP layer at times X+delta1, X+delta2, and so on. Each packet will have a discard timer running with a certain time. At the same time, all these five PDCP SDUs (IP packets) must be delivered within a defined time budget. If the delay budget for the application packet is consumed, the five PDCP SDUs corresponding to the application packet will be discarded regardless of whether the PDCP discard timer is running or not.

For example, if the first IP packet of the PDU set arrived and had a packet delay budget (PDB) left of Y ms, then the second IP packet from the PDU set which arrives after X+delta1 would have (Y−delta1) ms to be delivered. It would be similar for the rest of IP packet belonging to the given PDU set.

The value of the current PDCP discard timer cannot depend on the number of PDCP SDUs which may correspond to a single application PDU because this (the number of PDCP SDUs which correspond to a single application PDU) may vary from application PDU to application PDU. Setting the PDCP discard timer to a fraction of the maximum latency of the application PDU may also impose a fictitious restriction which may lead to unnecessary discards. For example, if the maximum latency is 10 ms and the PDCP discard timer is set to 2 ms, any single PDCP PDU will be discarded 2 ms after it reaches PDCP. In the example above, it could be so that all five PDCP PDUs are transmitted at the same time—after 7 ms from the reception of the first PDCP SDU. All PDPC PDUs may be delivered within the latency budget (e.g. 10 ms), however, if the discard timer was a fraction of the latency budget, few packets would have been already discarded.

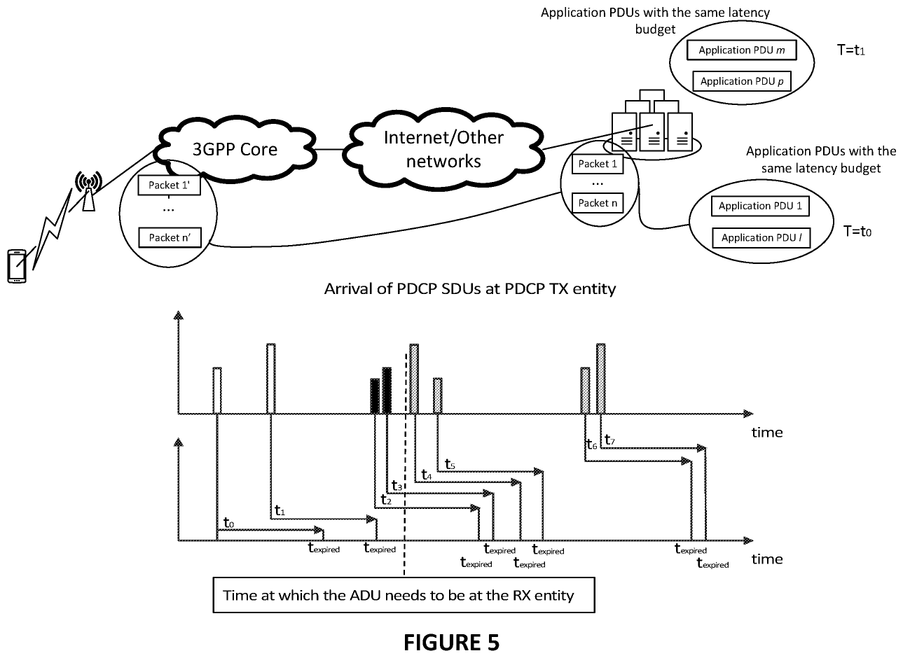

FIG. 5 exemplifies such a problem. FIG. 5 illustrates multiple PDCP packet arrivals from a single application PDU to motivate group PDCP dropping and new F1 signaling between the gNB Centralized Unit (CU) and Distributed Unit (DU). The application generates one or more application PDUs and all of the PDUs share the same latency budget (i.e. they need to be delivered within a maximum latency time). The application can also generate other additional application PDUs with a different latency bound or may generate PDUs at a later time. These application PDUs can traverse one or more network(s) or can be directly connected to a 3GPP network. In any case, these application PDUs may be adapted (e.g., segmented, etc.) by protocols below the application protocol to better fit the transmission properties. The challenge for the gNB (e.g. PDCP layer) is to identify the PDUs which belong to the set of application PDU set with the same latency bound and which ones need to be delivered first. For example, those generated at time t0 may need to be delivered before those generated at time t1.

A similar issue can happen in the uplink (UL). It could be the case that more than one PDCP SDU related to one application PDU arrives to the PDCP layer from the application layer. The UE needs to receive UL grants to transmit these PDCP SDUs. It may be so that the uplink grants do not come in time, or are not large enough, so that the time budget to deliver the application PDU is consumed and there are still PDCP SDUs related to the said application PDU pending for transmission. PDCP would still aim at transmitting those PDCP SDUs even if they are not any longer useful for the receiving party. Additionally, trying to transmit those “late” PDCP SDUs may actually delay other PDCP SDUs related to a second application PDU coming after the first application PDU.

Accordingly, the current PDCP timer is not efficient to handle XR services due to the following reasons:
An XR application may produce one or more application PDUs which must be delivered within a delay budget. The application or layers below the application may segment/concatenate these application PDUs.
PDCP receives from upper layers IP PDUs (if IP is used). However, PDCP does not have any information about how these PDCP SDU (IP PDUs) map to the application PDUs which need to be delivered within the same latency budget.
The existing PDCP discard timer for single PDCP SDU is not good enough to handle situations outlined in the bullets above.

When one application PDUs which should have been delivered within a certain latency bound are late, then the later application PDUs are no longer needed since the later application PDU will be dependent on the early application PDU for video decoding. The corresponding PDCP SDUs/PDUs should then not be transmitted either as it can result in a waste of resources. However, the existing independent discard timer between PDCP SDUs is not appropriate to handle this unique situation for XR traffic, i.e., allowing a longer stay of PDCP SDU in the buffer although they are not needed any more from an application perspective.

### F1 Interface

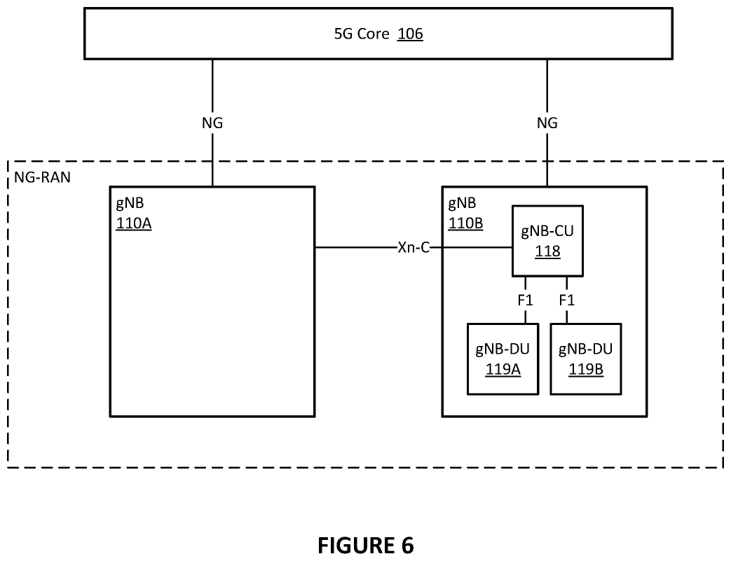

For downlink (DL) data, there is the F1 interface defined for control signaling between the gNB-CU 118 and gNB-DU(s) 119A/119B. As shown in FIG. 6, this interface is responsible for possible information and control signaling from the PDCP entity located in CU and the RLC entity located in DU. Previous efforts have been focused on the behavior of only the PDCP entity. However, in a real network, different modules are responsible for different protocol layers. Compared to the previous works, some embodiments described herein include the F1 signaling aspects in order to ensure that dropped packets in the CU 118 should be indicated to the DU 119 via the F1 interface to avoid any potential confusion in lower layers and potential redundant transmissions. It is noted that the terms “DU” and “gNB-DU” will be used in the following embodiments interchangeably; the terms “CU” and “gNB-CU” will be used in the following embodiments interchangeably.

The embodiments described herein provide mechanisms at a gNB-DU for deriving the delivery requirements and handling of the PDCP PDUs when the requirements are met, or not. A gNB-CU can select an appropriate DU for the handling the PDCP PDUs and their associated requirements. According to some embodiments:
A DU can derive the requirements that an ADU and, therefore, the PDCP PDUs associated to the said ADU.
The DU can derive the requirements implicitly, e.g. requirements established for the DRB or explicitly, e.g. by the CU indicating for each ADU or each PDCP PDU associated to an ADU.
The DU can estimate whether it can or cannot meet the requirements for the given ADU.
If the DU cannot meet the (e.g. latency) requirements, it can identify the PDCP PDUs which might not be able meet the requirements and would signal to the CU the identified PDCP PDUs.
The CU can transmit the indicated PDCP PDUs to a second DU, i.e., a second DU leg connected over F1 signaling. The F1 signaling can include updated requirements for the given PDCP PDUs, e.g., it could provide the PDB left, or it may indicate an importance indication so that the DU prioritizes these packets over other packets.
The first DU can discard the identified PDCP PDUs, or the CU can indicate to the first DU to discard the one or more of the identified PDCP PDUs. In this case, the following scenarios may exist: 1) DU can drop PDUs, 2) DU cannot drop PDUs, or 3) DU can drop PDUs only if indicated by CU.

When IP packets associated to a given PDU set arrive at the CU, the CU decides to which DU the PDCP SDUs will be transmitted, given there are more than one DU connected to the device.

### DU Selection Mechanism

The DU selection process can be based on a CU's knowledge of the traffic load capacity of each DU and/or of each DU's buffering information.

In one general embodiment, the DU selection process can be based on a network implementation method.

In another embodiment, the DU selection process by the CU can be initially set-up statically, for example, based on the network deployment. The CU can then refine the DU selection based on the reported UE measurements.

In another embodiment, the DU selection process by the CU can be done based on statistical information relevant to ADU level packet delivery. This information can include statistical parameters of ADU latency such as X percentile, mean and variance. DU can measure ADU latency based on indication of ADU for each RLC SDU (or PDCP PDU). For example, ADU latency can be measured from the first RLC SDU arrival time to the successful reception of last RLC SDU belonging to one ADU. Similarly, ADU bit rate at DU can be estimated by dividing sum of RLC SDUs bits of one ADU by a corresponding ADU latency. The statistical information of ADU bit rate measured in DU such as Y percentile, mean or variance can be reported to CU to aid DU selection. It is also possible to report ADU error rate which can be measured by counting the error event of ADU delivery in DU withing ADU latency requirement. Once the DU has measured/determined the statistical information associated with ADU transmission, this information can be signaled to CU as the part of assistance information data. A signaling example is provided below with reference to 3GPP TS 38.425.

In one embodiment, the CU receives assistance information from the DU(s) including ADU level statistical information, such as the latency of ADU from a previous transmission, if it has existed before. This can make the DU selection process a dynamic memory-based approach.

In one embodiment, the information the CU receives can be based on ADU statistical information from the DU. In another embodiment, the information can come from the GTP-U extension header sent to PDCP.

An example of an Assistance Information Data information element, with the addition of an “ADU statistical information” field, is shown below with reference to 3GPP TS 38.425 vl7.0.0:

### ASSISTANCE INFORMATION DATA (PDU Type 2)

This frame format is defined to allow the node hosting the PDCP entity to receive assistance information.

The following shows the respective ASSISTANCE INFORMATION DATA frame.

FIG. 5.5.2.3-1: ASSISTANCE INFORMATION DATA (PDU Type 2) Format

| Bits | | | | | | | | Number of |
|---|---|---|---|---|---|---|---|---|
| 7 | 6 | 5 | 4 | 3 | 2 | 1 | 0 | Octets |

| PDU Type (=2) | PDCP | Assistance | UL | DL | 1 |
|---|---|---|---|---|---|
| | Dupl. | Info. | Delay | Delay | |
| | Ind. | Ind. | Ind. | Ind. | |

| Spare | PDCP | 1 |
|---|---|---|
| | Duplication | |
| | Activation | |
| | Suggestion | |

| Number of Assistance Information Fields | 0 or 1 |
|---|---|
| Assistance Information Type | 0 or (2*Number |
| Number of octets for Radio Quality Assistance Information Fields | of Assistance |
| Radio Quality Assistance Information | Info Fields + |
| | sum of Number |
| | of octets for |
| | Radio Quality |
| | Assistance |
| | Information |
| | Fields) |
| UL Delay DU Result | 0 or 4 |
| DL Delay DU Result | 0 or 4 |
| ADU statistical information | 0 or M |

NOTE 1:
All information elements defined in FIG. 5.5.2.3-1 are also applicable to E-UTRA PDCP unless specified otherwise in section 5.5.3.

### ADU Statistical Information

Description: This parameter indicates the number of successful DL transmissions (of an ADU)
Value range: {0 . . . 2^{N}−1}.
Field length: M octet.

In another general embodiment, assistance data providing ADU statistical information from the node hosting RLC can be signaled in the GTP-U extension header sent to the node hosting PDCP.

Once an appropriate DU has been selected, the CU can inform the DU of the ADU requirements and may additionally provide assistance information to the gNB-DU, such as the number of PDCP SDUs associated with a given PDU set or the PDU set size. Requirements may be derived implicitly by the gNB. For example, a DRB may already consider or deliver certain QoS under a certain latency threshold. ADU requirements may be, for instance, the Packet Delay Budget (PDB) or PDB left (i.e. PDB minus the queued time). Other information can be parameters related to the 5QI associated with this DRB QoS flow.

### DU Feedback to CU on ADU Treatment

Considering the service/delivery and ADU requirements, together with the associated ADU information, the gNB-DU may calculate the time and resources to deliver the corresponding PDCP PDUs (RLC SDUs) for the given ADU. The gNB-DU may at some moment estimate that it might not be able to meet the requirements for that said ADU. This may mean that the gNB-DU might not be able to deliver all RLC SDUs within the given PDB, for instance. The RLC SDUs may have arrived or not to the gNB-DU depending on whether the CU is able to provide assistance information to the gNB-DU. When the gNB-DU estimates that it might not meet the requirements, such as the ADU level latency, for the given ADU, the gNB-DU informs the CU. The gNB-DU may provide one or more of the following information:
List of PDCP PDUs Sequence Number (SN) or Traffic Flow Identifier which might not meet the one or more of the ADU requirements
Minimum PDCP PDU SN which might not meet the one or more of the ADU requirements (other SNs after the indicated one implicitly might not either meet the requirements)
(Average) Delivery time for PDU sets
Indication whether the gNB-DU intends to transmit the indicated PDCP PDUs, or whether it intends to discard the indicated PDCP PDUs.

When the CU receives this indication, the CU can perform one or more of the following actions:
If the CU has a connection towards another gNB-DU leg over F1, it may transmit the indicated PDCP PDUs to this gNB-DU. The DU selection of this second DU by the CU can follow one or more of the embodiments above.
If the CU has a Dual Connectivity (DC) connection with a second gNB connected to the UE, it may transmit the indicated PDCP PDUs to the second gNB (or gNB-CU) over appropriate Xn-U signaling. Once received, the gNB signals it to the DU handling the UE over F1-U. As in the first case, the CU may provide requirements and assistance information to the second gNB (e.g. second gNB-CU and gNB-DU). Additionally, it may also set a flag indicating the importance of or low PDB left for these PDCP PDUs.
If the CU does not have a DC connection: 1) the CU can decide to discard the indicated PDCP PDUs; or 2) if it exists, the CU can indicate to the application service via specific APIs or other signaling to reduce the size of future ADUs.
If additional information was provided by the DU, the CU may further evaluate the best path to transmit future ADUs given, for instance, the delivery time for PDU sets indicated by the first DU, and the PDB or PDB left of next ADUs.

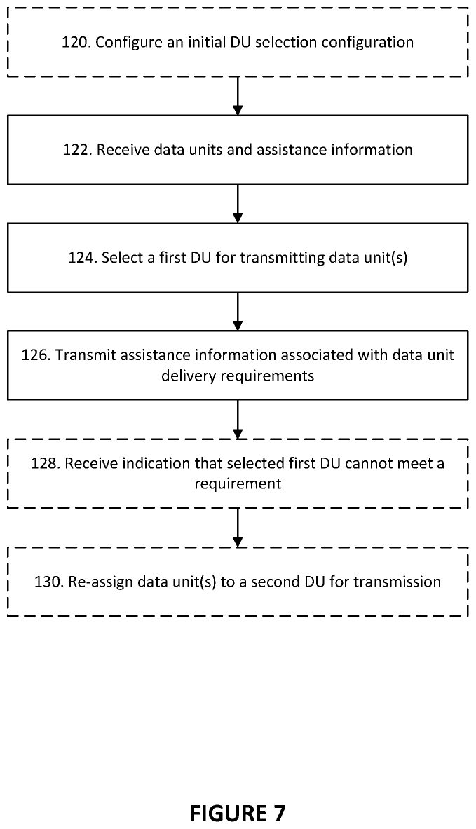

FIG. 7 is a flow chart illustrating a method which can be performed by a network node such as a Centralized Unit (CU) of an access node (e.g. CU 118 in base station/gNB 110) as described herein. The method can include:

Step 120: Optionally, the CU can configure an initial DU selection configuration indicating to which DU of the access node one or more data units (e.g. ADUs, SDUs, PDUs) should be transmitted.

Step 122: The CU receives data units (e.g. ADUs, PDUs, PDU Set, etc.) and associated assistance information. The assistance information can be received from a core network node (e.g. UPF) or alternatively from a DU. In some embodiments, the data units and assistance information can be received together. In some embodiments, the data units and assistance information can be received separately. In some embodiments, the assistance information is received in a GTP-U extension header. In some embodiments, the assistance information is received in an Assistance Information Data information element.

The assistance information can include ADU statistical information (e.g. PDU Set Sequence Number, PDU Set Size, PDU sequence number within the PDU Set, importance indication, latency parameter(s), etc.) as described herein.

In some embodiments, the initial DU selection configuration can be modified in accordance with the received assistance information.

Step 124: The CU can select a first DU for transmitting at least one data unit based at least in part on the received assistance information and/or the initial DU selection configuration.

Step 126: The CU transmits the data units and the associated assistance information to the selected first DU. In some embodiments, the assistance information is transmitted in a GTP-U extension header. In some embodiments, the assistance information is transmitted in an Assistance Information Data information element.

In some embodiments, the CU can provide further information (e.g. additional assistance information or delivery requirements) to the DU including: an indication of which groups of RLC SDUs belong to a unique ADU which needs to be delivered within the same time budget, an indication of enabling a decision to drop/discard PDCP and/or RLC PDUs related to the ADU group(s) at the RLC layer, a number of PDCP SDUs associated to a given PDU set or the PDU set size, and/or parameters related to the 5QI associated with the DRB.

Step 128: Optionally, the CU receives an indication that the selected first DU cannot meet a requirement(s) associated with one or more data units.

Step 130: In response to receiving the indication that the selected first DU cannot meet a requirement(s) associated with one or more data units, the CU can select a second DU and re-assign those identified data units to the second DU for transmission. In some embodiments, the CU transmits the indicated data units (e.g. PDCP PDUs) to the second DU over F1 signaling. In some embodiments, the CU can transmit the indicated data units (e.g. PDCP PDUs) to a second CU over Xn signaling to re-assign the data units for transmission.

In some embodiments, data and information is provided from the PDCP layer of the CU. In some embodiments, the data and information is provided to the RLC layer of the DU.

In some embodiments, a timer for discarding data units can be signaled by a PDCP entity of the CU.

It will be appreciated that one or more of the above steps can be performed simultaneously and/or in a different order. Also, steps illustrated in dashed lines are optional and can be omitted in some embodiments.

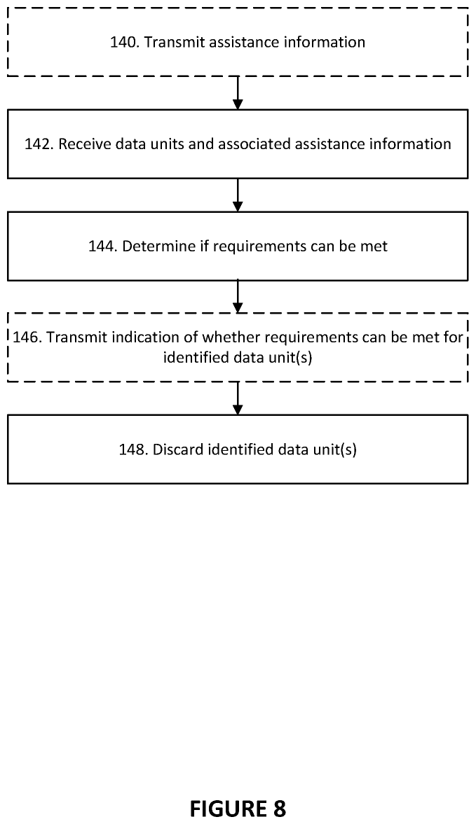

FIG. 8 is a flow chart illustrating a method which can be performed by a network node such as a Distributed Unit (DU) of an access node (e.g. DU 119 of base station/gNB 110) as described herein. The method can include:

Step 140: Optionally, the DU can generate assistance information and transmit it to a CU. The assistance information can include ADU statistical information (e.g. latency parameter) as described herein.

Step 142: The DU receives data units (e.g. ADUs, PDUs, PDU Set, etc.) and associated assistance information from a CU. In some embodiments, the data units and assistance information can be received together. In some embodiments, the data units and assistance information can be received separately. In some embodiments, the assistance information is received in a GTP-U extension header. In some embodiments, the assistance information is received in an Assistance Information Data information element.

The assistance information can include ADU statistical information (e.g. PDU Set Sequence Number, PDU Set Size, PDU sequence number within the PDU Set, importance indication, latency parameter(s), etc.) as described herein.

In some embodiments, the DU can derive one or more requirements for an ADU.

Step 144: The DU determines/estimates if it can meet one more requirement(s) associated with a data unit. The DU can identify one or more data units that cannot be delivered (e.g. and will be discarded) according to their requirements. For example, the DU may determine that it cannot deliver some or all RLC SDUs within a given PDB or latency threshold or other delivery requirement. The determination can be based at least in part of the received assistance information. In some embodiments, the determination can be in accordance with the importance indication parameter.

Step 146: Optionally, the DU transmits an indication of whether it will transmit or discard/drop a data unit (e.g. an identified set of PDCP PDUs). In some embodiments, responsive to determining that a requirement associated with a particular data unit cannot be met, the DU signals the CU to indicate that the requirement cannot be met.

Step 148: The DU can discard the identified data unit(s) in accordance with the determination. In some embodiments, the DU can receive an instruction from the CU indicating to drop the identified data unit(s).

It will be appreciated that one or more of the above steps can be performed simultaneously and/or in a different order. Also, steps illustrated in dashed lines are optional and can be omitted in some embodiments.

In some embodiments, a wireless device such as UE 112 can be configured to transmit and/or receive user data and/or application data via the telecommunication network 102. Transmitting or receiving the user data and/or application data can cause a network node (such as gNB 110) to perform the steps of FIGS. 7 and/or 8.

Some embodiments described herein provide for enhancing the F1 signaling between the gNB-CU and gNB-DU to allow for efficient PDCP PDUs handling for XR service, for example. The F1-U signaling extension can give flexibility to the network (CU) to refine the DU selection, by choosing the DU(s) most capable of handling XR traffic characteristics. Information can be included to indicate the PDCP PDUs that can be delivered in their entirety according one or more requirements. As such, a DU has flexibility to decide which packets to handle and which packets to drop.

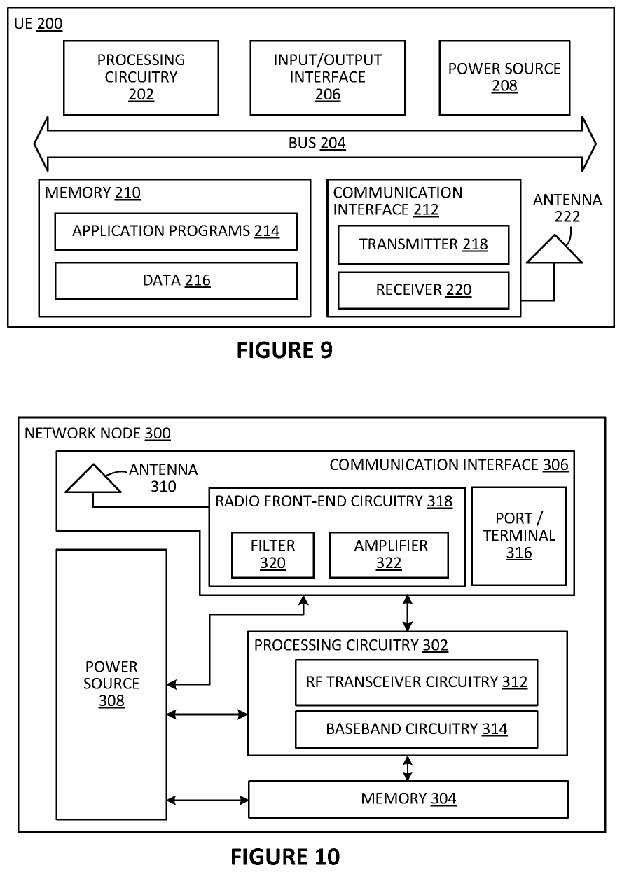

FIG. 9 shows a UE 200, which may be an embodiment of the UE 112 of FIG. 4 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 300, which may be an embodiment of the access node 110 or the core network node 108 of FIG. 4, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 10 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

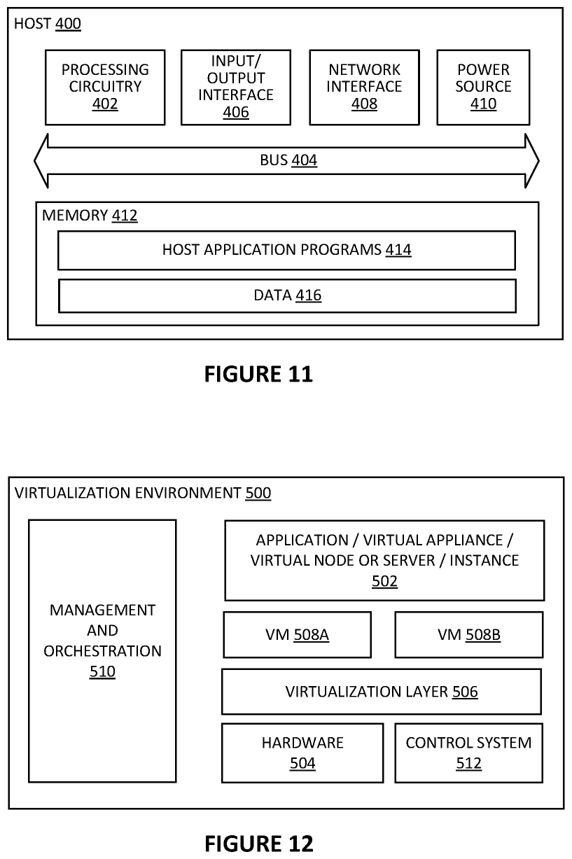

FIG. 11 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 9 and 10, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

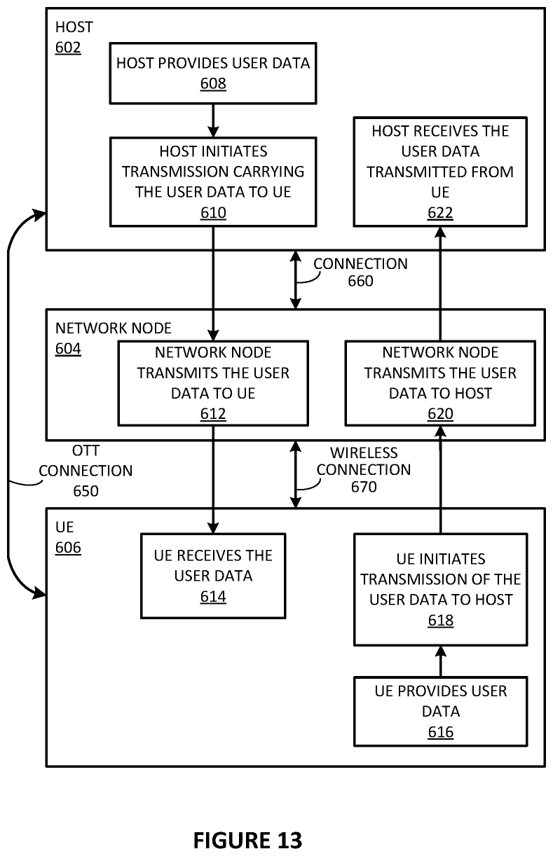

FIG. 13 shows a communication diagram of a host 602 communicating via a network node 604 with a UE 606 over a partially wireless connection in accordance with some embodiments. Example implementations, in accordance with various embodiments, of the UE (such as a UE 112A of FIG. 4 and/or UE 200 of FIG. 9), network node (such as network node 110A of FIG. 4 and/or network node 300 of FIG. 10), and host (such as host 116 of FIG. 4 and/or host 400 of FIG. 11) discussed in the preceding paragraphs will now be described with reference to FIG. 13.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the handling of colliding signals and/or channels and thereby provide benefits such as improving measurement latency and bypassing the measurement gap request procedure to improve positioning quality.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a radio access node centralized unit (CU), the method comprising:
receiving a packet data unit (PDU) Set and associated PDU Set assistance information;
selecting a radio access node distributed unit (DU) for transmitting the PDU Set based at least in part on the PDU Set assistance information; and
transmitting the PDU Set and the associated PDU Set assistance information to the selected DU.

2. The method of claim 1, wherein the PDU Set assistance information is received in a GTP-U extension header.

3. The method of any one of claims 1 to 2, wherein the PDU Set assistance information includes at least one of: a PDU Set Sequence Number, a PDU Set Size, and a PDU sequence number within the PDU Set.

4. The method of any one of claims 1 to 3, further comprising, receiving an importance indication indicating a relative importance of the PDU Set compared to at least one other PDU Set.

5. The method of claim 4, wherein the importance indication is included in the received PDU Set assistance information.

6. The method of claim 4, wherein the selection of the DU is in accordance with the importance indication.

7. The method of any one of claims 1 to 6, further comprising, receiving an indication of whether the PDU Set will be transmitted or discarded from the selected DU.

8. The method of claim 7, further comprising, in response to receiving the indication, transmitting the PDU Set and the associated PDU Set assistance information to a second DU over F1 signaling.

9. The method of any one of claims 1 to 8, further comprising, transmitting the PDU Set and the associated PDU Set assistance information to a second CU over Xn signaling.

10. The method of any one of claims 1 to 9, wherein the PDU Set assistance information is transmitted, to the selected DU, in a GTP-U extension header.

11. The method of any one of claims 1 to 9, wherein the PDU Set assistance information is transmitted, to the selected DU, in an Assistance Information Data information element.

12. The method of any one of claims 1 to 11, further comprising, transmitting, to the selected DU, an importance indication indicating a relative importance of the PDU Set compared to at least one other PDU Set.

13. The method of claim 12, wherein the importance indication is included in the transmitted PDU Set assistance information.

14. A radio access node centralized unit (CU) comprising a radio interface and processing circuitry configured to:
receive a packet data unit (PDU) Set and associated PDU Set assistance information;
select a radio access node distributed unit (DU) for transmitting the PDU Set based at least in part on the PDU Set assistance information; and
transmit the PDU Set and the associated PDU Set assistance information to the selected DU.

15. The CU of claim 14, wherein the PDU Set assistance information is received in a GTP-U extension header.

16. The CU of any of claims 14 to 15, wherein the PDU Set assistance information includes at least one of: a PDU Set Sequence Number, a PDU Set Size, and a PDU sequence number within the PDU Set.

17. The CU of any of claims 14 to 16, further configured to receive an importance indication indicating a relative importance of the PDU Set compared to at least one other PDU Set.

18. The CU of claim 17, wherein the importance indication is included in the received PDU Set assistance information.

19. The CU of any of claims 17 to 18, wherein the selection of the DU is in accordance with the importance indication.

20. The CU of any of claims 14 to 19, further configured to receive an indication of whether the PDU Set will be transmitted or discarded from the selected DU.

21. The CU of claim 20, further configured to, in response to receiving the indication, transmit the PDU Set and the associated PDU Set assistance information to a second DU over F1 signaling.

22. The CU of any of claims 14 to 21, further configured to transmit the PDU Set and the associated PDU Set assistance information to a second CU over Xn signaling.

23. The CU of any of claims 14 to 22, wherein the PDU Set assistance information is transmitted, to the selected DU, in a GTP-U extension header.

24. The CU of any of claims 14 to 22, wherein the PDU Set assistance information is transmitted, to the selected DU, in an Assistance Information Data information element.

25. The CU of any of claims 14 to 24, further comprising, transmitting, to the selected DU, an importance indication indicating a relative importance of the PDU Set compared to at least one other PDU Set.

26. The CU of claim 25, wherein the importance indication is included in the transmitted PDU Set assistance information.

27. A method performed by a radio access node distributed unit (DU), the method comprising:
receiving a packet data unit (PDU) Set and associated PDU Set assistance information from a radio access node centralized unit (CU);
determining whether the PDU Set will be transmitted or discarded based at least in part on the PDU Set assistance information; and
discarding the PDU Set in accordance with the determination.

28. The method of claim 27, further comprising, transmitting the PDU Set in accordance with the determination.

29. The method of any one of claims 27 to 28, further comprising, transmitting, to the CU, an indication of whether the PDU Set will be transmitted or discarded.

30. The method of claim 29, wherein the indication includes at least one of: a PDU sequence number, a Traffic Flow identifier, and a delivery time for the PDU Set.

31. The method of any one of claims 27 to 30, wherein the PDU Set assistance information is received in a GTP-U extension header.

32. The method of any one of claims 27 to 30, wherein the PDU Set assistance information is received in an Assistance Information Data information element.

33. The method of any one of claims 27 to 32, wherein the PDU Set assistance information includes at least one of: a PDU Set Sequence Number, a PDU Set Size, and a PDU sequence number within the PDU Set.

34. The method of any one of claims 27 to 33, further comprising, receiving an importance indication indicating a relative importance of the PDU Set compared to other PDU Sets.

35. The method of claim 34, wherein the importance indication is included in the received PDU Set assistance information.

36. The method of any one of claims 34 to 35, wherein the determination of whether the PDU Set will be transmitted or discarded is in accordance with the importance indication.

37. The method of any one of claims 27 to 36, further comprising, receiving delivery requirements associated with the PDU Set including at least one of: a latency requirement, a QoS requirement, and a packet delay budget information.

38. The method of claim 37, wherein the determination of whether the PDU Set will be transmitted or discarded is further in accordance with the delivery requirements.

39. A radio access node distributed unit (DU) comprising a radio interface and processing circuitry configured to:
receive a packet data unit (PDU) Set and associated PDU Set assistance information from a radio access node centralized unit (CU);
determine whether the PDU Set will be transmitted or discarded based at least in part on the PDU Set assistance information; and
discard the PDU Set in accordance with the determination.

40. The DU of claim 39, further configured to transmit the PDU Set in accordance with the determination.

41. The DU of any one of claims 39 to 40, further configured to transmit, to the CU, an indication of whether the PDU Set will be transmitted or discarded.

42. The DU of claim 41, wherein the indication includes at least one of: a PDU sequence number, a Traffic Flow identifier, and a delivery time for the PDU Set.

43. The DU of any one of claims 39 to 42, wherein the PDU Set assistance information is received in a GTP-U extension header.

44. The DU of any one of claims 39 to 42, wherein the PDU Set assistance information is received in an Assistance Information Data information element.

45. The DU of any one of claims 39 to 44, wherein the PDU Set assistance information includes at least one of: a PDU Set Sequence Number, a PDU Set Size, and a PDU sequence number within the PDU Set.

46. The DU of any one of claims 39 to 45, further configured to receive an importance indication indicating a relative importance of the PDU Set compared to other PDU Sets.

47. The DU of claim 46, wherein the importance indication is included in the received PDU Set assistance information.

48. The DU of any one of claims 46 to 47, wherein the determination of whether the PDU Set will be transmitted or discarded is in accordance with the importance indication.

49. The DU of any one of claims 39 to 48, further configured to receive delivery requirements associated with the PDU Set including at least one of: a latency requirement, a QoS requirement, and a packet delay budget information.

50. The DU of claim 49, wherein the determination of whether the PDU Set will be transmitted or discarded is further in accordance with the delivery requirements.
